(19) United States
(12) Patent Application Publication
(10) Pub. No.: US 2022/0159948 A1
(43) Pub. Date: May 26, 2022

(54) Antimicrobial and Antiviral Paper Products Including Silver Ions

(71) Applicant: Hoffmaster Group, Inc., Clintonville, WI (US)

(72) Inventors: Russell A. Berthiaume, Pittsfield, NH (US); Mark S. Hunter, Suamico, WI (US); Dana S. Laplume, Rochester, NH (US); William C. Nelson, Jr., Appleton, WI (US)

(21) Appl. No.: 17/534,777

(22) Filed: Nov. 24, 2021

Related U.S. Application Data
(63) Continuation of application No. 17/451,657, filed on Oct. 21, 2021.
(60) Provisional application No. 63/117,903, filed on Nov. 24, 2020.

(51) Int. Cl. A01N 25/10; A01N 59/16; A01P 1/00

(52) U.S. Cl. CPC A01N 25/10; A01P 1/00; A01N 59/16

(57) ABSTRACT

Aspects of the present disclosure include antimicrobial and/or antiviral disposable articles made of cellulosic fiber and comprising silver ions. The disposable articles include napkins, guest towels, placemats, and tray mats, and these articles can be used in schools, hospitals, clinics, doctor's offices, dental offices, long term and assisted living facilities, and restaurant and foodservice facilities.

This application in a Continuation-in-Part of U.S. application Ser. No. 17/451,657, filed Oct. 21, 2021, and also claims the benefit of priority to U.S. Provisional Application No. 63/117,903, filed Nov. 24, 2020, which are both incorporated by reference in their entirety.

The present disclosure is directed to the field of antimicrobial and/or antiviral products made of cellulosic fiber. More specifically, the disclosure is directed to disposable cellulose fiber-based articles comprising silver ions, wherein the articles, such as napkins, guest towels, placemats, and tray mats, have antimicrobial and/or antiviral properties.

Disposable paper products are used in a variety of situations in order to provide protection against potentially dirty surfaces, for personal hygiene, and cleanup. As result of the global concern for health and well-being, there is presently an increasing concern for cleanliness and sanitization.

While conventional disposable paper products provide a barrier, they can themselves become contaminated and therefore provide limited protection.

A need exists for a disposable article made of cellulosic fiber that can prevent the growth of unwanted microbes and viruses which may come in contact with the disposable article. Furthermore, it is desirable to inhibit microorganisms and viruses that may cause product degradation, discoloration, staining, and/or odors.

The present disclosure provides a disposable cellulose fiber-based article comprising silver ions, the article having antimicrobial and/or antiviral properties that may be used in schools, hospitals, clinics, doctor's offices, dental offices, long-term and assisted-living facilities, and restaurant and foodservice facilities.

One aspect of the present disclosure is directed to an absorbable cellulose fiber-based product, including at least one layer of material having a first side and a second side, wherein the absorbable product is an antimicrobial and/or antiviral product. The absorbable cellulose fiber-based product comprising a silver ion coating on at least one of the first side and the second side of the product. The silver ion coating may include a concentration of at least 1%, such as from 1% to 10%. The silver content in the cellulose fiber-based product may range from 0.5 ppm to 1,000 ppm, depending on the desired end use. The at least one layer of material may form a napkin, a guest towel, a placemat, or a traymat. The at least one layer of material may include at least one dimple, ridge, bump, or recess. The at least one layer of material may include a preformed fold or perforation.

### BRIEF DESCRIPTION OF THE DRAWINGS

FIG. 1a illustrates a napkin or guest towel in accordance with an aspect of the disclosure.

FIG. 1b illustrates a napkin or guest towel having two folds in accordance with an aspect of the disclosure.

FIG. 1c illustrates a napkin or guest towel having four folds in accordance with an aspect of the disclosure.

FIG. 1d illustrates a napkin or guest towel forming a pocket in accordance with an aspect of the disclosure.

FIG. 2 illustrates a placemat in accordance with an aspect of the disclosure.

FIG. 3 illustrates a traymat in accordance with an aspect of the disclosure.

FIG. 4 illustrates a flexographic printing apparatus used for making disposable cellulose fiber-based articles having antimicrobial and/or antiviral properties in accordance with one aspect of the disclosure.

FIG. 5 illustrates a gravure coating apparatus used for making disposable cellulose fiber-based articles having antimicrobial and/or antiviral properties in accordance with one aspect of the disclosure.

FIGS. 6a-21d are photographs of various Staphylococcus aureus and Klebsiella pneumoniae sample test swatches following an incubation period.

The cellulose fiber-based products of the present disclosure utilize the antimicrobial and/or antiviral properties of silver. Studies revealed that the antimicrobial and/or antiviral properties of silver are due to its ionized form, Ag+, and its ability to cause damage to cells by interacting with proteins and DNA. By binding with tissue proteins, structural changes in cell walls and intracellular and nuclear membranes occur, preventing or hindering cell replication. Additionally, the ions interfere with enzyme production stopping the cell from producing energy. The cellulose fiber-based articles of the present disclosure incorporate silver ions to provide a durable, non-leachable antimicrobial and/or antiviral treatment, that is capable of disrupting the spread of bacteria, fungi, and other microorganisms. The cellulosic fiber-based articles may include any plant or tree-based paper type product. The antimicrobial and/or antiviral properties imparted to the article during manufacturing creates a barrier that prevent bacteria, fungi, or other microorganisms to live on the surface of the article.

The concentration of silver in the cellulose fiber-based products of the present disclosure are dependent on the desired end use. In certain embodiments, the amount of silver in the cellulose fiber-based products can range from 0.5 ppm to 1000 pmm. The term “ppm” refers to the μg of silver per one gram of the cellulose fiber-based product.

In certain embodiments, the desired end use is directed to antimicrobial products. Non-limiting examples of the concentrations ranges in the antimicrobial products include, but are not limited to, from 0.5 ppm to 700 ppm, from 0.5 ppm to 600 ppm, from 2 ppm to 600 ppm, from 2 ppm to 400 ppm, from 2 ppm to 350 ppm, from 2 ppm to 300 ppm, from 2 ppm to 250 ppm, from 2 ppm to 200 ppm, from 2 ppm to 150 ppm, from 2 ppm to 100 ppm, from 2 ppm to 50 ppm, from 2 ppm to 40 ppm, from 2 ppm to 30 ppm, from 2 ppm to 20 ppm, from 3 ppm to 200 ppm, from 3 ppm to 150 ppm, from 3 ppm to 100 ppm, from 3 ppm to 50 ppm, from 5 ppm to 200 ppm, from 5 ppm to 150 ppm, from 5 ppm to 100 ppm, from 5 ppm to 50 ppm, from 10 ppm to 200 ppm, from 10 ppm to 150 ppm, from 10 ppm to 100 ppm, and from 10 ppm to 50 ppm.

In certain embodiments, the desired end use is directed to antiviral products. Non-limiting examples of the concentrations ranges in the antiviral products include, but are not limited to, from 1 ppm to 1,000 ppm, from 1 ppm to 750 ppm, from 2 ppm to 600 ppm, from 3 ppm to 400 ppm, from 3 ppm to 350 ppm, from 5 ppm to 300 ppm, from 5 ppm to 250 ppm, from 5 ppm to 200 ppm, from 5 ppm to 150 ppm, from 5 ppm to 100 ppm, from 5 ppm to 75 ppm, from 5 ppm to 60 ppm, from 5 ppm to 50 ppm, from 10 ppm to 300 ppm, from 10 ppm to 250 ppm, from 10 ppm to 200 ppm, from 10 ppm to 150 ppm, from 10 ppm to 100 ppm, from 10 ppm to 75 ppm, from 10 ppm to 60 ppm, from 10 ppm to 50 ppm, from 20 ppm to 300 ppm, from 20 ppm to 250 ppm, from 20 ppm to 200 ppm, from 20 ppm to 150 ppm, from 20 ppm to 100 ppm, from 20 ppm to 75 ppm, from 20 ppm to 60 ppm, and from 20 ppm to 50 ppm.

The cellulose fibers used in accordance with the present disclosure may include any plant or tree-based paper-type product. In certain embodiments, the cellulose fibers can be convention fibers know as wood pulp fibers, which are made by breaking down wood chips from softwoods and/or hardwoods. Pulp from softwoods is known to impart good flexibility, high folding strength, good tensile strength, and/or printability; pulp from hardwoods is known to impart strong absorptivity, high opaqueness, high thickness, and/or high stiffness. Certain embodiments of the present disclosure use a blend of softwood and hardwood pulps to optimize at least some of these desirable characteristics. The cellulose fibers used in accordance with the present disclosure can also comprise non-wood fibers including, but not limited to: gramineous fiber materials, such as bamboo, bagasse, rice straw, wheat straw, sorghum residue, corn straw, and reed; bast fiber materials such as lax, jute, hemp, ramie and kenaf; seed hull fiber materials, such as cotton and cotton linters; and leaf fiber materials such as sugarcane leaves, banana leaves, and abaca leaves. In addition, recycled fibers, which may contain all of the abovementioned sources of fiber sources, can be used in accordance with the present disclosure.

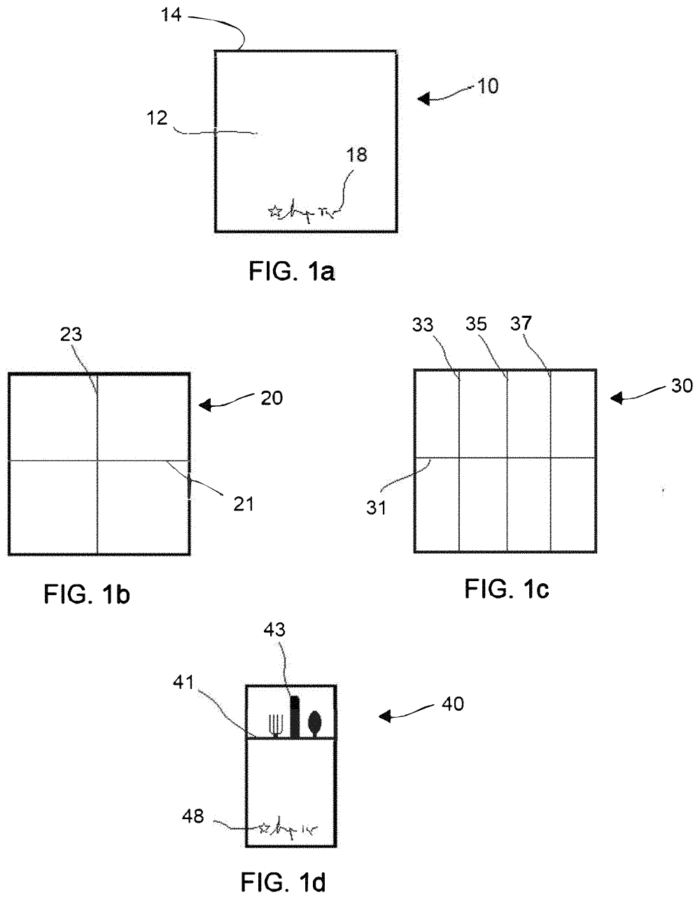

FIGS. 1a-1d illustrates a disposable cellulosic fiber-based article in accordance with an aspect of the disclosure. For example, FIG. 1a illustrates a napkin or guest towel 10 having a square shape. These napkins or guest towels can function as an alternative to linen and cloth napkins. In certain embodiments, one napkin or guest towel can last for an entire meal. In other embodiments, the napkin or guest towel can be used to protect cutlery, either by rolling or folding. While a square article is shown in FIG. 1a, the napkin or guest towel 10 may have any desired shape including, but not limited to, round, oval, rectangular, irregular, or triangular. The napkin or guest towel 10 may include at least one ply of material. At least one ply of material may include several plies arranged in any manner. For example, a first ply may be arranged in a first direction and a second ply may be arranged in a direction opposite the first direction or perpendicular to the first direction. The napkin or guest towel 10 may have a thickness ranging from 0.5 mm to 5 mm, such as, for example, from 0.5 mm to 4 mm, from 0.5 mm to 3 mm, from 0.5 mm to 2 mm, and from 0.5 mm to 1 mm.

The napkin or guest towel 10 may have a first surface 12 and a second surface 14 opposite the first surface 12. The first surface 12, second surface 14, or both the first 12 and second 14 surfaces may be smooth or may include at least one dimple, ridge, bump or recess.

For example, the first 12 and second 14 surfaces may be covered in a plurality of dimples and bumps configured to increase the surface area and increase ability of the napkin or guest towel 10 to absorb fluid. Additionally, the first 12 or second 14 surfaces may include one or more monograms, logos, images, or designs 18. The monogram, logo, image, or design 18 may be embossed, printed, adhered, or otherwise included on the first 12 or second 14 surface of the napkin or guest towel 10.

In order to provide antimicrobial and/or antiviral properties to the napkin or guest towel 10 silver ions may be incorporated into the napkin or guest towel 10. The silver ions may be incorporated onto or within the first surface 12, the second surface 14, or both the first 12 and second 14 surfaces. The silver ions may be incorporated into the napkin or guest towel 10 using any suitable process such as by coating, spraying, printing, rolling, or otherwise incorporating silver ions onto or into napkin or guest towel 10. The silver ions may be applied to the napkin or guest towel in the form of a silver ion solution having a concentration of at least 1%, such as a concentration in the range of from 1% to 20% by volume, such as, for example, from 1% to 15%, from 1% to 10%, from 1% to 5%, from 1% to 3%, from 2% to 10%, from 2% to 5%, and from 2% to 3%. A solution having a small concentration of silver ions is odorless, colorless, and tasteless. It is understood that coating may include dip coating, spray coating, gravure coating, or any other coating process that imparts silver ions onto or within first 12 and/or second 14 surfaces. Additionally, printing may include flexographic, ink, or any printing process that integrates silver ions onto or within first 12 or second 14 surfaces.

The napkin or guest towel 10 may include at least one preformed fold or perforation. FIG. 1b illustrates a napkin or guest towel 20 in accordance with another aspect of the disclosure. Napkin or guest towel 20 includes a first fold 21 and a second fold 23. In certain embodiments, this napkin or guest towel can be used for meals at schools, meals at healthcare settings, meals at long-term and assisted-living facilities, and meals from food establishments, including take-out meals. As illustrated, the first 21 and second 23 folds may lie perpendicular to one another. Such an arrangement may allow for napkin or guest towel 20 to achieve a square having one-quarter the area of the napkin or guest towel 20 when unfolded. While not illustrated, it is understood that napkin or guest towel 20 may include one or more folds positioned at other locations. For example, one or more folds may extend from a first corner to a corner opposite the first corner in order to allow the napkin or guest towel 20 to assume a triangular shape when folded. Additionally, as shown in FIG. 1c, napkin or guest towel 30 may include a first fold 31, a second fold 33, a third fold 35, and a fourth fold 37. Such an arrangement of folds allows for the napkin or guest towel 30 to form a rectangular shape having one-eighth the area of the napkin or guest towel 30 when unfolded.

FIG. 1d illustrates a napkin or guest towel 40 in accordance with another aspect of the disclosure. Napkin or guest towel 40 may include at least one preformed fold or perforation that allows the napkin or guest towel 40 to form a pocket 41. Pocket 41 may be used to hold cutlery 43 in an environment in which food is served, such as schools, hospitals, long-term and assisted-living facilities, and restaurant and foodservice facilities. Additionally, napkin or guest towel 40 may be used in a medical setting, such as a physician's office, dentist's office, and long-term and assisted-living facilities, to hold medical tools and equipment. In such a setting, pocket 41 may be configured to hold sterilized tools before being used in a procedure. As illustrated, napkin or guest towel 40 may include one or more monograms, designs, markings, symbols, words, or phrases 48 to indicate or identify what tools may be located within pocket 41.

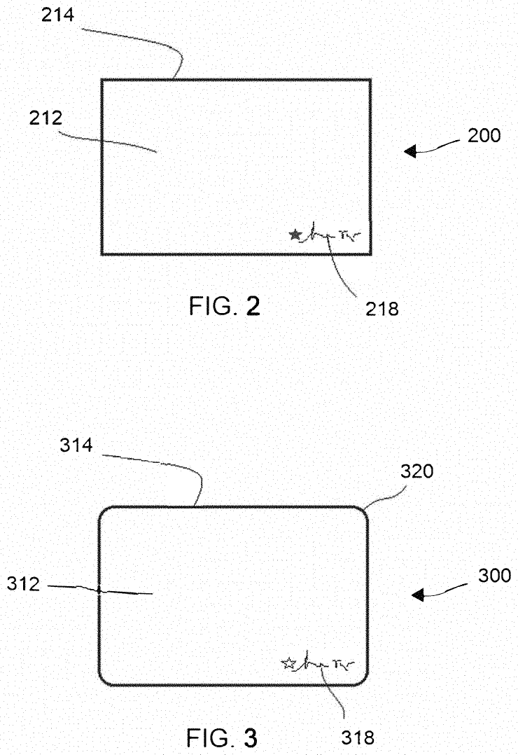

FIG. 2 illustrates another disposable cellulose fiber-based article having antimicrobial and/or antiviral properties in accordance with another aspect of the present disclosure. FIG. 2 shows a placemat 200 having a first surface 212 and a second surface 214. Placemat 200 may be used to provide a barrier on a surface such as a table, countertop, or bar top. While the placemat 200 is shown to have a rectangular configuration, it is understood that placemat 200 may have any desired shape including, but not limited to, circular, triangular, oval, square, irregular, or even the form of a caricature. Placemat 200 may be of any desired dimension. Non-limiting examples include placements having a width from 12 inches to 36 inches and a length from 12 inches to 48 inches. For example, placemat 200 may have a width of 12 inches to 18 inches and a length of 16 inches to 30 inches. Additionally, placemat 200 may be configured to have a smaller area, such as for use as a drink coaster. The placemat 200 may have a thickness ranging from 0.5 mm to 5 mm, such as, for example, from 0.5 mm to 4 mm, from 0.5 mm to 3 mm, from 0.5 mm to 2 mm, and from 0.5 mm to 1 mm.

The first surface 212, second surface 214, or both the first 212 and second 214 surfaces may be smooth or may include at least one dimple, ridge, bump or recess. For example, the first 212 and second 214 surfaces may be covered in a plurality of dimples and bumps configured to increase the surface area and increase ability of the placemat 200 to absorb fluid. Additionally, the first 212 or second 214 surfaces may include one or more monograms, designs, logos, images, or other visual representation 218. The monogram, design, logo, image, or other visual representation 218 may be embossed, printed, adhered, or otherwise included on the first 212 or second 214 surface of the placemat 200.

Placemat 200 may be placed on a table or other surface to provide a safe surface to place food, bowls, cups, plates, and silverware. In order to provide anti-microbial properties to the placemat 200 silver ions may be incorporated into the placemat 200. The silver ions may be incorporated onto or within the first surface 212, the second surface 214, or both the first 212 and second 214 surfaces. The silver ions may be incorporated into the placemat 200 using any suitable process such as by coating, printing, rolling, or otherwise incorporating silver ions onto or into placemat 200. The silver ions may be applied to the placemat 200 in the form of a silver chloride solution having a concentration in the range of from 1% to 20% by volume, such as, for example, from 1% to 15%, from 1% to 10%, from 1% to 5%, from 1% to 3%, from 2% to 10%, from 2% to %, and from 2% to 3% any manner as previously discussed.

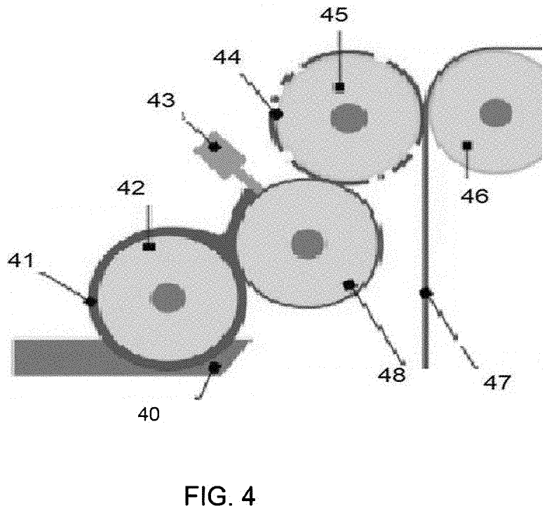

FIG. 3 illustrates another disposable cellulose fiber-based article having antimicrobial and/or antiviral properties in accordance with an aspect of the present disclosure. FIG. 3 shows a traymat 300 having a first surface 312 and a second surface 314. Placemat 300 may be used to provide a barrier on a surface of reusable trays. Traymat 300 includes a generally rectangular configuration having rounded corners 320. Rounded corners 320 are configured to allow the traymat to fit within the raised edges of a reusable tray. It is understood that traymat 300 may include any shape as desired to fit within a reusable tray. The first surface 312, second surface 314, or both the first 312 and second 314 surfaces may be smooth or may include at least one dimple, ridge, bump or recess. For example, the first 312 and second 314 surfaces may be covered in a plurality of dimples and bumps configured to increase the surface area and increase ability of the traymat 300 to absorb fluid. Additionally, the first 312 or second 314 surfaces may include one or more monograms, designs, logos, images, or other visual representation 318. The monogram, design, logo, image, or other visual representation 318 may be embossed, printed, adhered, or otherwise included on the first 312 or second 314 surface of the traymat 300.

Traymat 300 may be placed on reusable tray to provide a safe surface to place food, bowls, cups, plates, and silverware. In order to provide anti-microbial properties to traymat 300, silver ions may be incorporated into the traymat. The silver ions may be incorporated onto or within the first surface 312, the second surface 314, or both the first 312 and second 314 surfaces. The silver ions may be incorporated into the traymat 300 using any suitable process such as by coating, printing, rolling, or otherwise incorporating silver ions onto or into traymat 300. The silver ions may be applied to the traymat 300 in the form of a silver chloride solution having a concentration in the range of from 1% to 20% by volume, such as, for example, from 1% to 15%, from 1% to 10%, from 1% to 5%, from 1% to 3%, from 2% to 10%, from 2% to 5%, and from 2% to 3% in any manner as previously discussed.

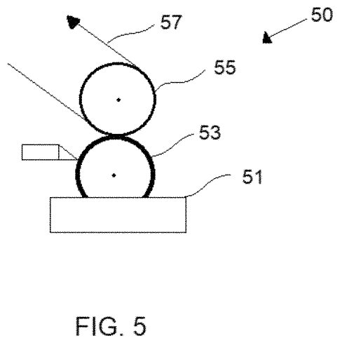

FIG. 4 illustrates a flexographic printing apparatus used for making disposable fiber-based articles having antimicrobial and/or antiviral properties in accordance with one aspect of the disclosure. FIG. 4 illustrates a tray 40, ink 41, fountain cylinder 42, doctor blade 43, flexible plate 44, plate cylinder 45, impression cylinder 46, substrate 47, and anilox cylinder 48. The plate cylinder 45 may include flood coat sleeves to produce the fiber-based articles with antimicrobial and/or antiviral properties.

In certain embodiments, a first print deck may be used to flood coat an extender onto the article to aid in retention of the 2% silver chloride solution in the article substrate, and a second print deck may be used to flood coat extender and the 2% silver chloride solution. Alternatively, first and second print decks may be used to add extender and 2% silver chloride solution, or inks and 2% silver chloride solution

The 2% silver chloride solution may be added in the range of 1% to 10% by volume, such as, for example, from 1% to 5%, from 1% to 3%, from 2% to 5% and from 2% to 3%. The extender may include different minerals, selected to give different properties required in the ink. These can differ in their particle size, particle size distribution, degree of aggregation and particle shape as well as the mineral chemistry. GCC (ground calcium carbonate), PCC (precipitated calcium carbonate), kaolin clay and talc are examples of extenders used in water-based Flexographic processes. In certain embodiments, the use of an extender mixed with 2% silver chloride solution has improved retention, and reduced waste from tray 40 during the printing process, i.e., the process can be run continuously without having to shut down and purge the “ink” tray system, due to buildup of the aforementioned chemicals.

In further embodiments, the silver chloride solution can further comprise an organic acid. Nonlimiting examples of such organic acids include, but are not limited to, tribasic acids such as citric acid.

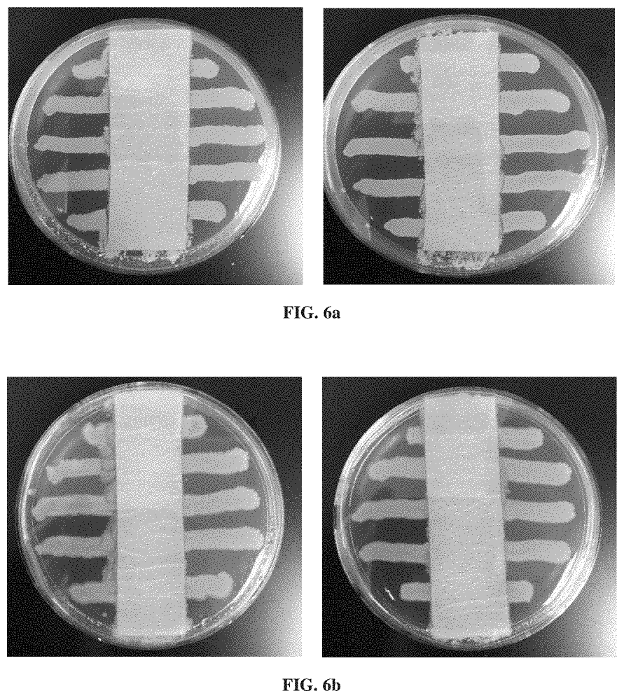

In one example, a two-sided, printed placemats may be produced by first flexographic printing the placemats and then using a gravure coater 50 as illustrated in FIG. 5 to apply the 2% silver chloride solution on both sides of the web 57. Silicone may be added to the 2% silver chloride solution as required by the finished product specifications. As shown in FIG. 5, a tray 51 may hold a 2% silver chloride solution. Gravure coater 50 includes an engraved roll 53 and a backup roll 55. The web (or placemat) 57 passes through the engraved roll 53 and the backup roll to apply a coating of silver ions.

### EXAMPLE

The process of producing antimicrobial placemats includes the following components:
36# Resolute Alternative Offset Paper; 36# is the calculated weight of 500 sheets on the 24″ by 36″ scale.
Sanden Express 1000 Web Printing Press—Capable of producing antimicrobial placemats at high speeds. Able to print up to 6 colors on one side of sheet or up to 4 colors on one side and up to 2 colors on the back side at the same time. Capable of producing an embossed (linen textured) or plain sheet.
QuadTech Silicone Coater 4000, Original purpose of coater is to apply silicone to the web to eliminate web static electricity and helps prevent marking of the web by downstream equipment. Our use applies an antimicrobial coating to one or both sides of the web.

Once all components are collected, the process is as follows. The process starts with preparing a press to run, which has the following detailed steps. A paper roll is mounted onto the press, a web is run through the press, and a sheeter is adjusted. The sheeter is able to cut the web in 14-inch sheets and deliver the cut sheets to a stacker, which collects the sheets by stacking them one atop of another.

2% silver chloride in solution is mixed with 58% citric acid in solution at a rate of 20% 2% silver chloride in solution and 80% 58% citric acid in solution. This creates the antimicrobial solution.

Next is the set-up of the QuadTech Silicone Coater 4000. The paper is webbed between the two coater rollers before entering the sheeter. All hoses are checked for correct attachment. The filter is attached (this filter is reusable and is washed out after each use) on the return line.

The reservoir tank is filled with the antimicrobial solution. The reservoir tank is plumbed into the fountains; both valves are turned ON for the fountains. There are two fountains in total; one for the front sheet coater and one for the back sheet coater. This arrangement is depicted in FIG. 5.

The main power switch in turned on for the QuadTech Silicone Coater 4000. Motors 1 and 2 are adjusted to the proper rotation and speed using the plus and minus keys of each motor to a desired setting.

The run mode of the press is initiated, and the press speed is adjusted to 600 ft/min before the QuadTech Silicone Coater 4000 is turned on by pressing the auto key for motors 1 and 2.

Front sheet coater roller (motor #2) is set at 30% (forward rotation), which is 30% more than the 600 ft/min press speed and opposite direction of the web, and the back sheet coater roller (motor #1) is set at −33% (reverse rotation), which is 33% more than 600 ft/min press speed and opposite direction of web.

Once the press speed is 200 fpm or more, the coater rollers engage the web automatically allowing antimicrobial solution to coat both the front and back of web.

### Example 2

The efficacy testing on paper mats (20% Biomaster/80% Conacid, 30% Reverse, 10% Override) per ISO 20743 “Textiles-Determination of Antibacterial Activity of Textile Products” was performed. This international standard provides quantitative methods to determine the antibacterial activity of all antibacterial textile products, including nonwovens.

The standard provides three different methods to test the antibacterial efficacy of the paper mats. The user can select the appropriate method based on the intended application, the environment in which the product is to be used, and the surface properties of the product. The methods differ only by the manner in which the bacterial suspensions, i.e., the test organism(s), are inoculated onto the fabric. Based on the absorbent properties of the paper mats, the absorption method was selected.

The absorption method tests the ability of the product to kill bacterial species that are placed directly into contact with the product. A known concentration (1.0-3.0×105 CFU/ml) of two different species of bacteria were inoculated onto the surface of the paper mats. One of the species, Staphylococcus aureus, tests the effectiveness of the paper mats on gram-positive organisms. Klebsiella pneumonia was used to test the effectiveness of the paper mats on gram-negative organisms.

Following the preparation of the test organisms, specimens of both the control and test samples were cut into 0.4 gram sections and placed into separate sterile test tubes. Six specimens of each were used to test each of the bacteria cultures. This allowed for each culture and fabric to be tested in triplicate. The untreated, or control specimens, were used as a baseline to which the test specimens could be compared. Following preparation of both the control and test specimens, each was inoculated with the test culture suspensions. Half of the specimens were inoculated with the Staphylococcus aureus, while the second half was inoculated with the Klebsiella pneumonia.

Following the inoculation of the specimens, half of the control and test specimens for both test organisms were placed into an incubator for 24 hours. The remaining inoculated specimens were diluted with a known quantity of physiological saline solution and “shaken out”. These resultant solutions were serially diluted and plated for each specimen. These samples would represent the bacterial count immediately after inoculation.

Following the 24-hour incubation of the second set of specimens, these samples were diluted with a known quantity of physiological saline solution and “shaken out”. The resultant solutions were serially diluted and plated for each specimen. These samples would represent the bacterial count following the 24-hour incubation period.

The counts recovered from both sets of specimens were used to establish an “Antibacterial Activity Value (A)”. This value is defined as the difference of the growth value of the treated specimens from the untreated specimens. The growth values are defined below.

F=Growth Value of Untreated (Control) Specimen (lg Cₜ−lg C₀)
Cₜ—Bacteria Counts on Control following 24-hour incubation period
C₀—Bacteria Counts on Control immediately after inoculation

G=Growth Value of Treated (Test) Specimen (lg Tₜ−lg T₀)
Tₜ—Bacteria Counts on Test Specimen following 24-hour incubation period
T₀—Bacteria Counts on Test Specimen immediately after inoculation

Antibacterial Activity A=F−G

The data and for the paper mats treated with Biomaster and Concaid is listed below.

| | Staphylococcus | Klebsiella |
|---|---|---|
| Bacteria | aureus | pneumoniae |
| Strain Number | ATCC 6538 ™ | ATCC 4352 ™ |
| Concentration of Inoculum | 1.1 × 10⁵ | 1.4 × 10⁵ |
| Growth Value of F (lg Cₜ-lg C₀) | 4.0 | 4.2 |
| Growth Value of G (lg Tₜ-lg T₀) | 3.0 | 2.4 |
| Antibacterial Activity Value “A” | 1.0 | 1.8 |

| | |
|---|---|
| Measuring Method | Plate Count Method |
| Type of Material | Paper Mats Treated Biomaster - |
| | (27 ppm Ag) and Concaid (.39% CA) |
| Incubation Time | 24 hours |

The paper mats treated with Concaid (0.39% Citric Acid) and Biomaster (27 ppm of silver), were able to achieve weak to moderate antibacterial activity values for both organisms tested. The antibacterial activity value for Staphylococcus aureus was 1.0. The antibacterial activity value for Klebsiella pneumoniae was 1.8. Both of those values show that the paper mats control the bacteria species more than the control, but not at a level that is considered “significant” by the method. The ISO 20743 states that any Antimicrobial Value “A” less than 2 is not significant. A value greater than 2 is significant, and a value greater than 3 is considered strong.

### Example 3

Testing on a napkin (5% Biomaster) per ISO 20743 was performed. Based on the absorbent properties of the napkins, the absorption method of this standard was selected.

Following the preparation of the test organisms, specimens of both the treated and untreated test fabrics were cut into 0.4 gram sections and placed into separate sterile test tubes. Six specimens of each, the treated and untreated, were used to test each of the bacteria cultures. This allowed for each culture and fabric to be tested in triplicate. The untreated, or control specimens, were used as a baseline to which the treated specimens could be compared. Following preparation of both the treated and untreated specimens, each was inoculated with the test culture suspensions. Half of the specimens were inoculated with the Staphylococcus aureus, while the second half was inoculated with the Klebsiella pneumonia.

Following the inoculation of the specimens, half of the treated and untreated specimens for both test organisms were placed into an incubator for 24 hours. The remaining inoculated specimens were diluted with a known quantity of physiological saline solution and “shaken out”. These resultant solutions were serially diluted and plated for each specimen. These samples would represent the bacterial count immediately after inoculation.

Following the 24-hour incubation of the second set of specimens, these samples were diluted with a known quantity of physiological saline solution and “shaken out”. The resultant solutions were serially diluted and plated for each specimen. These samples would represent the bacterial count following the 24-hour incubation period.

The counts recovered from both sets of specimens were used to establish an “Antibacterial Activity Value (A)”. The data for the antibacterial activity and the silver concentration for the napkins treated with Biomaster is listed below.

| | Staphylococcus | Klebsiella |
|---|---|---|
| Bacteria | aureus | pneumoniae |
| Strain Number | ATCC 6538 ™ | ATCC 4352 ™ |
| Concentration of Inoculum | 1.3 × 10⁵ | 1.4 × 10⁵ |
| Growth Value of F (lg Cₜ-lg C₀) | 4.6 | 3.9 |
| Growth Value of G (lg Tₜ-lg T₀) | −0.5 | 0.0 |
| Antibacterial Activity Value “A” | 5.1 | 3.9 |

| | |
|---|---|
| Measuring Method | Plate Count Method |
| Type of Material | Napkins Treated with 10% Biomaster |
| | (340 ppm Ag) |
| Incubation Time | 24 hours |

The napkins treated with 160 ppm of silver, by way of Biomaster, were able to achieve very strong antibacterial activity values for both organisms tested. The antibacterial activity value for Staphylococcus aureus was 4.8. The antibacterial activity value for Klebsiella pneumoniae was 3.0. Any value over 3.0 is considered strong and shows that the treatment is very effective in killing and controlling the test organisms.

### Example 4

The efficacy testing on a napkin (10% Biomaster) per ISO 20743 was performed. Based on the absorbent properties of the napkins, the absorption method of this standard was selected.

Following the preparation of the test organisms, specimens of both the treated and untreated test fabrics were cut into 0.4 gram sections and placed into separate sterile test tubes. Six specimens of each, the treated and untreated, were used to test each of the bacteria cultures. This allowed for each culture and fabric to be tested in triplicate. The untreated, or control specimens, were used as a baseline to which the treated specimens could be compared. Following preparation of both the treated and untreated specimens, each was inoculated with the test culture suspensions. Half of the specimens were inoculated with the Staphylococcus aureus, while the second half was inoculated with the Klebsiella pneumonia.

Following the inoculation of the specimens, half of the treated and untreated specimens for both test organisms were placed into an incubator for 24 hours. The remaining inoculated specimens were diluted with a known quantity of physiological saline solution and “shaken out”. These resultant solutions were serially diluted and plated for each specimen. These samples would represent the bacterial count immediately after inoculation.

Following the 24-hour incubation of the second set of specimens, these samples were diluted with a known quantity of physiological saline solution and “shaken out”. The resultant solutions were serially diluted and plated for each specimen. These samples would represent the bacterial count following the 24-hour incubation period.

The counts recovered from both sets of specimens were used to establish an “Antibacterial Activity Value (A)”. The data for the antibacterial activity and silver concentration for the napkins treated with Biomaster is listed below.

| | Staphylococcus | Klebsiella |
|---|---|---|
| Bacteria | aureus | pneumoniae |
| Strain Number | ATCC 6538 ™ | ATCC 4352 ™ |
| Concentration of Inoculum | 1.3 × 10⁵ | 1.4 × 10⁵ |
| Growth Value of F (lg Cₜ-lg C₀) | 4.6 | 3.9 |
| Growth Value of G (lg Tₜ-lg T₀) | −0.5 | 0.0 |
| Antibacterial Activity Value “A” | 5.1 | 3.9 |

| | |
|---|---|
| Measuring Method | Plate Count Method |
| Type of Material | Napkins Treated with 10% Biomaster |
| | (340 ppm Ag) |
| Incubation Time | 24 hours |

The napkins treated with 340 ppm of silver, by way of Biomaster, were able to achieve very strong antibacterial activity values for both organisms tested. The antibacterial activity value for Staphylococcus aureus was 5.1. The antibacterial activity value for Klebsiella pneumoniae was 3.9. Any value over 3.0 is considered strong and shows that the treatment is very effective in killing and controlling the test organisms.

### Example 5

The Silver Assay by ICP-OES and the efficacy testing per AATCC Test Method 147 “Antimicrobial Activity Assessment of Textile Materials: Parallel Streak Method” were performed on a tissue (high). The Silver Assay provided the silver concentration per weight of sample. The efficacy test method provides a qualitative look into the ability of the silver to resist or retard growth of aerobic bacteria.

A brief explanation of both procedure and complete results for the test is provided below. A portion of the sample was placed into a microwave digester with Nitric and Hydrochloric Acids and heated to 200° C. and 500 psi of pressure. This process completely digests all of the sample and ensures the silver is in solution. Once in solution, the silver is analyzed using an ICP-OES Spectroscopy against known certified standards for concentration. This concentration is calculated based on the weight of the sample digested.

The sample was analyzed per AATCC Test Method 147 using Staphylococcus aureus and Klebsiella pneumoniae as the test organisms. Staphylococcus aureus represent the gram-positive microorganisms, while Klebsiella pneumoniae will provide data for gram negative species. Following the preparation of Staphylococcus aureus and Klebsiella pneumoniae, nutrient agar was poured into sterile petri dishes and allowed to cool. Once cooled, the test organism was inoculated onto the agar making five parallel streaks.

Test swatches were prepared by cutting out portions of the tissues. The swatches were laid out, face down, perpendicular to the inoculum, and incubated for 24 hours at 37±2° C. The plates were observed following the incubation period. The observations include examining the agar under the specimens for growth, as well as examining each swatch for a zone of inhibition. Zone of inhibition is defined as an area around each specimen in which the bacteria will not grow.

The silver results are listed below. These results are an average of two different samples run in duplicate. For the silver concentration, <1 ppm (ug silver/gm of Sample) was found.

The following observations following the incubation period were observed. For Staphylococcus aureus, there was no interruption of growth under specimen, and no formation of a distinct zone of inhibition. The zone of inhibition was 0 mm. For Klebsiella pneumoniae there was no interruption of growth under specimen, and no formation of a distinct zone of inhibition. The zone of inhibition was 0 mm.

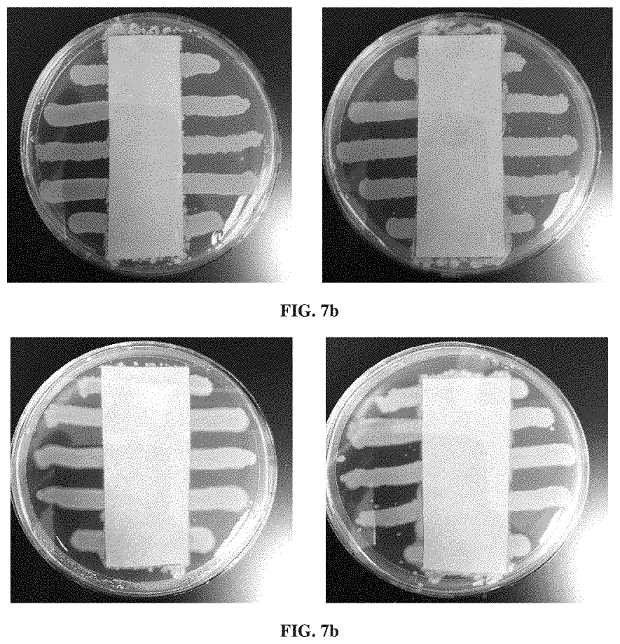

The face of the tissues was unable to interrupt the growth of either inoculum. There were no detectable levels of silver in the tissues. No zone of inhibition was observed for either the Staphylococcus aureus or the Klebsiella pneumoniae. FIG. 6a depicts Staphylococcus aureus in contact with the sample; FIG. 6b depicts Klebsiella pneumoniae in contact with the sample.

These results suggest that the tissue does not have sufficient anti-microbial properties on the surface to resist the growth of the bacteria inoculum streaked under the specimen. The silver treatment was not applied in a high enough concentration to be effective. The lack of a zone of inhibition suggests that there is no migration or leaching of any antimicrobial component out of the tissue that may “push back” the outlying growth.

### Example 6

The Silver Assay by ICP-OES and the efficacy testing per AATCC Test Method 147 were performed on a guest towel (high). Test swatches were prepared by cutting out portions of the guest towels. The swatches were laid out, face down, perpendicular to the inoculum, and incubated for 24 hours at 37±2° C. The plates were observed following the incubation period. The observations include examining the agar under the specimens for growth, as well as examining each swatch for a zone of inhibition. The zone of inhibition is defined as an area around each specimen in which the bacteria will not grow.

The silver results are listed below. These results are an average of two different samples run in duplicate. For the silver concentration, 34.0 ppm (ug silver/gm of Sample) was found.

The following observations following the incubation period were observed. For Staphylococcus aureus, there was a complete interruption of growth under the specimen. The zone of inhibition was 0 mm. For Klebsiella pneumoniae there was also a complete interruption of growth under the specimen. The zone of inhibition was 0 mm.

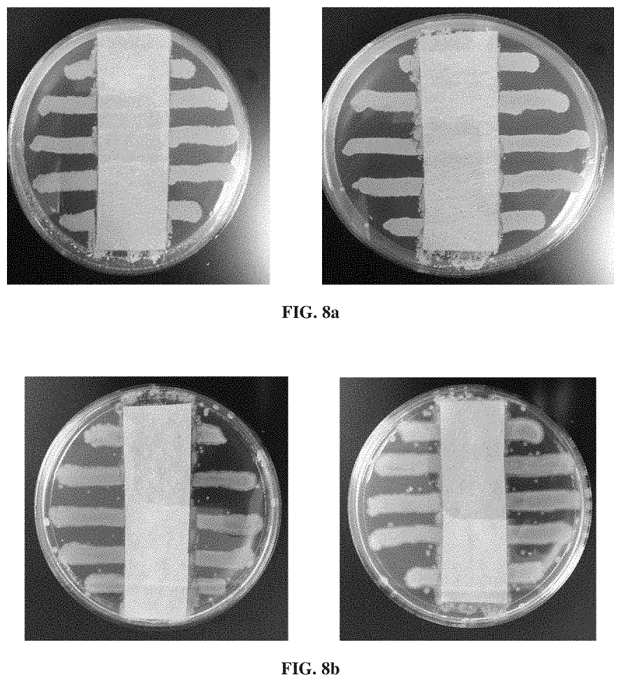

No formation of a distinct zone of inhibition was observed for either the Staphylococcus aureus or the Klebsiella pneumoniae. FIG. 7a depicts Staphylococcus aureus in contact with the sample; FIG. 7b depicts Klebsiella pneumoniae in contact with the sample.

These results suggest that the guest towels treated with 34.0 ppm of silver by way of Biomaster have sufficient anti-microbial properties to completely resist the growth of the bacteria inoculum streaked under the specimen. The face of the guest towel was able to fully limit the growth of both the gram-negative or gram-positive bacterium under the specimen. The lack of a zone of inhibition suggests that there is no migration or leaching of any antimicrobial component out of the guest towel that may “push back” the outlying growth.

### Example 7

The Silver Assay by ICP-OES and the efficacy testing per AATCC Test Method 147 were performed on a sample guest towel (0.6% 999 Biomaster). Test swatches were prepared by cutting out portions of the guest towels. The swatches were laid out, face down, perpendicular to the inoculum, and incubated for 24 hours at 37±2° C. The plates were observed following the incubation period. The observations include examining the agar under the specimens for growth, as well as examining each swatch for a zone of inhibition. The zone of inhibition is defined as an area around each specimen in which the bacteria will not grow.

The silver results are listed below. These results are an average of two different samples run in duplicate. For the silver concentration, 3.1 ppm (ug silver/gm of Sample) was found.

The following observations following the incubation period were observed. For Staphylococcus aureus, there was a partial interruption of growth under the specimen. The zone of inhibition was 0 mm. For Klebsiella pneumoniae there was also a partial interruption of growth under the specimen. The zone of inhibition was 0 mm.

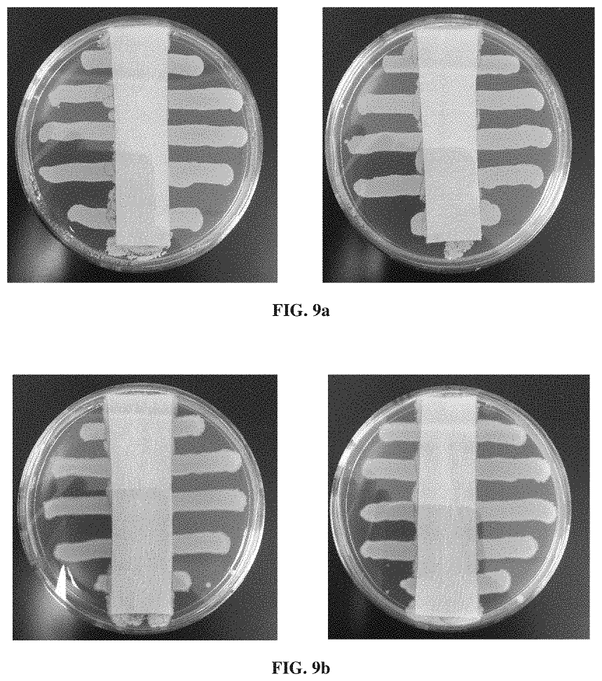

No formation of a distinct zone of inhibition was observed for either the Staphylococcus aureus or the Klebsiella pneumoniae. FIG. 8a depicts Staphylococcus aureus in contact with the sample; FIG. 8b depicts Klebsiella pneumoniae in contact with the sample.

The guest towels treated with 0.6% of the 999 Biomaster product (3.1 ppm of silver) were able to partially interrupt the growth of both the Staphylococcus aureus and Klebsiella pneumonia under the test specimens. Both species of bacterium can be seen growing on portions of agar/specimen interface. The full growth of the bacterium under the specimens was inhibited which is evident by the interruption of the inoculum streaks. The treated guest towels were not able to achieve a zone of inhibition with either inoculum.

These results suggest that the guest towels treated with 0.6% of the 999 Biomaster have low strength anti-microbial properties. The guest towels can partially resist the growth of the bacteria inoculum streaked under the specimens. The lack of a zone of inhibition suggests that there is no migration or leaching of any antimicrobial component out of the guest towel that may “push back” the outlying growth.

### Example 9

The Silver Assay by ICP-OES and the efficacy testing per AATCC Test Method 147 were performed on a sample of Tissue (1% 999 Biomaster). Test swatches were prepared by cutting out portions of the tissues. The swatches were laid out, face down, perpendicular to the inoculum, and incubated for 24 hours at 37±2° C. The plates were observed following the incubation period. The observations include examining the agar under the specimens for growth, as well as examining each swatch for a zone of inhibition. The zone of inhibition is defined as an area around each specimen in which the bacteria will not grow.

The silver results are listed below. These results are an average of two different samples run in duplicate. For the silver concentration, 5.3 ppm (ug silver/gm of Sample) was found.

The following observations following the incubation period were observed. For Staphylococcus aureus, there was a partial interruption of growth under the specimen. The zone of inhibition was 0 mm. For Klebsiella pneumoniae there was also a partial interruption of growth under the specimen. The zone of inhibition was 0 mm.

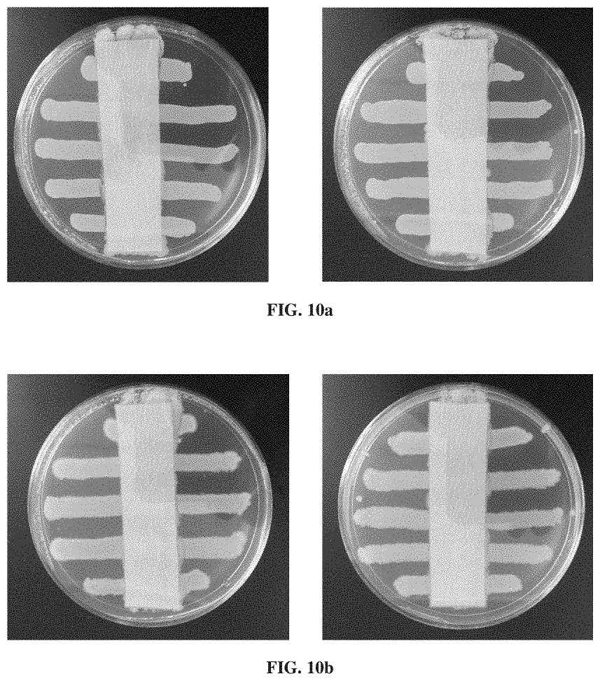

No formation of a distinct zone of inhibition was observed for either the Staphylococcus aureus or the Klebsiella pneumoniae. FIG. 9a depicts Staphylococcus aureus in contact with the sample; FIG. 9b depicts Klebsiella pneumoniae in contact with the sample.

The tissue treated with 1% of the 999 Biomaster product (5.3 ppm of silver) was able to partially interrupt the growth of both the Staphylococcus aureus and Klebsiella pneumonia under the test specimens. Both species of bacterium can be seen growing on portions of agar/specimen interface. The full growth of the bacterium under the specimens was inhibited which is evident by the interruption of the inoculum streaks. The treated tissues were not able to achieve a zone of inhibition with either inoculum.

These results suggest that the tissues treated with 1% Biomaster 999 do have low-mid strength anti-microbial properties. The tissues can partially resist the growth of the bacteria inoculum streaked under the specimens. The lack of a zone of inhibition suggests that there is no migration or leaching of any antimicrobial component out of the tissue that may “push back” the outlying growth.

### Example 10

The Silver Assay by ICP-OES and the efficacy testing per AATCC Test Method 147 were performed on a sample of tissue (2% 999 Biomaster). Test swatches were prepared by cutting out portions of the tissues. The swatches were laid out, face down, perpendicular to the inoculum, and incubated for 24 hours at 37±2° C. The plates were observed following the incubation period. The observations include examining the agar under the specimens for growth, as well as examining each swatch for a zone of inhibition. Zone of inhibition is defined as an area around each specimen in which the bacteria will not grow.

The silver results are listed below. These results are an average of two different samples run in duplicate. For the silver concentration, 14.0 ppm (ug silver/gm of Sample) was found.

The following observations following the incubation period were observed. For Staphylococcus aureus, there was a partial interruption of growth under the specimen. The zone of inhibition was 0 mm. For Klebsiella pneumoniae there was also a partial interruption of growth under the specimen. The zone of inhibition was 0 mm.

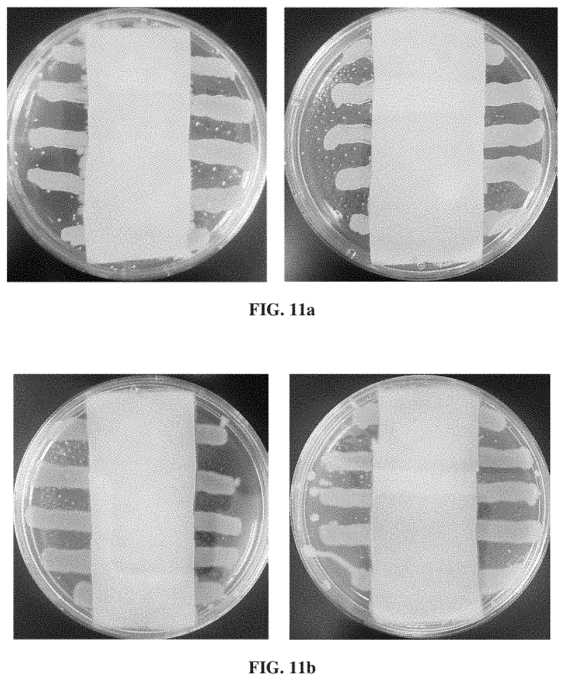

No formation of a distinct zone of inhibition was observed for either the Staphylococcus aureus or the Klebsiella pneumoniae. FIG. 10a depicts Staphylococcus aureus in contact with the sample; FIG. 10b depicts Klebsiella pneumoniae in contact with the sample.

The tissue treated with 2% of the 999 Biomaster product (14.0 ppm of silver) was able to partially interrupt the growth of both the Staphylococcus aureus and Klebsiella pneumonia under the test specimens. Both species of bacterium can be seen growing on portions of agar/specimen interface. The full growth of the bacterium under the specimens was inhibited which is evident by the interruption of the inoculum streaks. The treated tissues were not able to achieve a zone of inhibition with either inoculum.

These results suggest that the tissues treated with 2% of the 999 Biomaster do have low-mid strength anti-microbial properties. The tissues can partially resist the growth of the bacteria inoculum streaked under the specimens. The lack of a zone of inhibition suggests that there is no migration or leaching of any antimicrobial component out of the tissue that may “push back” the outlying growth.

### Example 11

The efficacy testing on paper mats (20% Biomaster/80% Conacid, 30% Reverse, 10% Override) per ISO 20743 “Textiles-Determination of Antibacterial Activity of Textile Products” was performed. For the silver concentration, 27.1 ppm (ug silver/gm of Sample) was found.

### Example 12

The efficacy testing on the sample per ISO 20743 “Textiles-Determination of Antibacterial Activity of Textile Products” was performed on sample of virgin fiber paper napkins treated with Biomaster added at 10% Concentration using Double Bump. Following the 24-hour incubation of the second set of specimens, these samples were diluted with a known quantity of physiological saline solution and “shaken out”. The resultant solutions were serially diluted and plated for each specimen. These samples would represent the bacterial count following the 24-hour incubation period.

The counts recovered from both sets of specimens were used to establish an “Antibacterial Activity Value (A)”.

The data for the antibacterial activity and the silver concentrations for the napkins treated with Biomaster are listed below.

| | Staphylococcus | Klebsiella |
|---|---|---|
| Bacteria | aureus | pneumoniae |
| Strain Number | ATCC 6538 ™ | ATCC 4352 ™ |
| Concentration of Inoculum | 1.1 × 10⁵ | 1.2 × 10⁵ |
| Growth Value of F (lg Cₜ-lg C₀) | 4.6 | 4.6 |
| Growth Value of G (lg Tₜ-lg T₀) | −0.9 | 0.0 |
| Antibacterial Activity Value “A” | 5.5 | 4.6 |

| | |
|---|---|
| Measuring Method | Plate Count Method |
| Type of Material/(Silver Conc.) | Napkins Treated with 10% |
| | Biomaster (610 ppm) |
| Incubation Time | 24 hours |

The napkins treated with 610 ppm of silver, by way of Biomaster, were able to achieve very strong antibacterial activity values for both organisms tested. The antibacterial activity value for Staphylococcus aureus was 5.5. The antibacterial activity value for Klebsiella pneumoniae was 4.6. Any value over 3.0 is considered strong and shows that the treatment is very effective in killing and controlling the test organisms.

### Example 13

The silver Assay by ICP-OES and the efficacy testing per AATCC Test Method 147 were performed on Oshkosh BioShield flatpacks. Test swatches were prepared by cutting out portions of the Flatpacks. The swatches were laid out, face down, perpendicular to the inoculum, and incubated for 24 hours at 37±2° C. The plates were observed following the incubation period. The observations include examining the agar under the specimens for growth, as well as examining each swatch for a zone of inhibition. The zone of inhibition is defined as an area around each specimen in which the bacteria will not grow.

The silver results are listed below. These results are an average of two different samples run in duplicate. For the silver concentration, 39.8 ppm (ug silver/gm of Sample) was found.

The following observations following the incubation period were observed. For Staphylococcus aureus, there was full interruption of growth under the specimen. The zone of inhibition was 0 mm. For Klebsiella pneumoniae there was a partial interruption of growth under the specimen. The zone of inhibition was 0 mm.

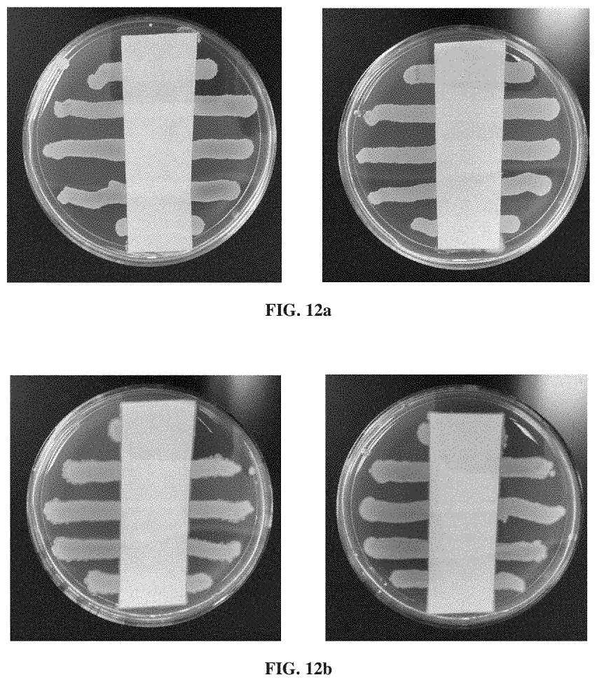

No formation of a distinct zone of inhibition was observed for either the Staphylococcus aureus or the Klebsiella pneumoniae. FIG. 11a depicts Staphylococcus aureus in contact with the sample; FIG. 11b depicts Klebsiella pneumoniae in contact with the sample.

These results suggest that Flatpacks treated with 39.8 ppm of silver have mid-high strength anti-microbial properties. The Flatpacks fully resisted the growth of Staphylococcus aureus bacteria inoculum streaked under the specimens. They partially resisted the growth of Klebsiella pneumonia bacteria inoculum streaked under the specimens. The lack of a zone of inhibition suggests that there is no migration or leaching of any antimicrobial component out of the Flatpacks that may “push back” the outlying growth.

### Example 14

The Silver Assay by ICP-OES and the efficacy testing per AATCC Test Method 147 were performed on 10½×14 Unmarked Mats (Ductor 100, Press Speed 600 FPM). Test swatches were prepared by cutting out portions of the Mats. The swatches were laid out, face down, perpendicular to the inoculum, and incubated for 24 hours at 37±2° C. The plates were observed following the incubation period. The observations include examining the agar under the specimens for growth, as well as examining each swatch for a zone of inhibition. Zone of inhibition is defined as an area around each specimen in which the bacteria will not grow.

The silver results are listed below. These results are an average of two different samples run in duplicate. For the silver concentration, 2.3 ppm (ug silver/gm of Sample) was found.

The following observations following the incubation period were observed. For Staphylococcus aureus, there was a partial interruption of growth under the specimen. The zone of inhibition was 0 mm. For Klebsiella pneumoniae there was also a partial interruption of growth under the specimen. The zone of inhibition was 0 mm.

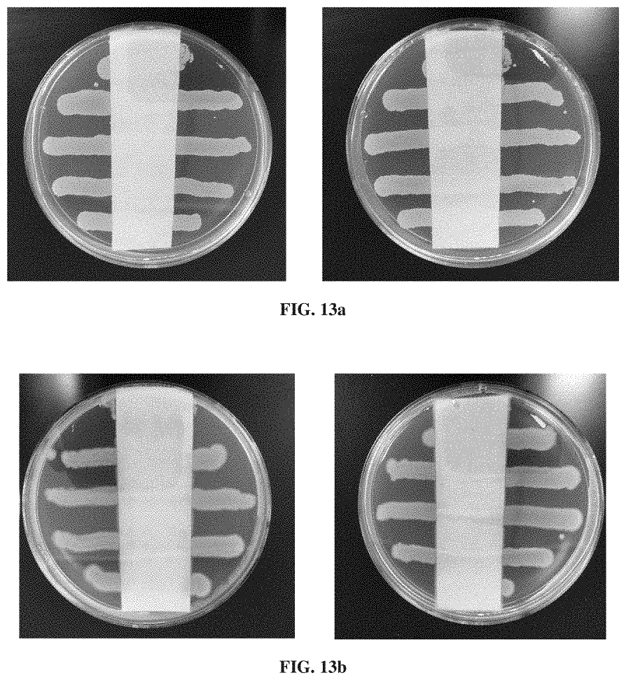

No formation of a distinct zone of inhibition was observed for either the Staphylococcus aureus or the Klebsiella pneumoniae. FIG. 12a depicts Staphylococcus aureus in contact with the sample; FIG. 12b depicts Klebsiella pneumoniae in contact with the sample.

Both species of bacterium can be seen growing on portions of agar/specimen interface. The full growth of the bacterium under the specimens was partially inhibited which is evident by the interruption of the inoculum streaks. The treated mats were not able to achieve a zone of inhibition with either inoculum.

These results suggest that mats treated with 2.3 ppm of silver by way of Biomaster have low-mid strength anti-microbial properties. The mats partially resisted the growth of the bacteria inoculum streaked under the specimens. The lack of a zone of inhibition suggests that there is no migration or leaching of any antimicrobial component out of the mats that may “push back” the outlying growth.

### Example 15

The Silver Assay by ICP-OES and the efficacy testing per AATCC Test Method 147 were performed on 10½×14 unmarked mats (Ductor 110, Press Speed 600 FPM). Test swatches were prepared by cutting out portions of the mats. The swatches were laid out, face down, perpendicular to the inoculum, and incubated for 24 hours at 37±2° C. The plates were observed following the incubation period. The observations include examining the agar under the specimens for growth, as well as examining each swatch for a zone of inhibition. Zone of inhibition is defined as an area around each specimen in which the bacteria will not grow.

The silver results are listed below. These results are an average of two different samples run in duplicate. For the silver concentration, 2.6 ppm (ug silver/gm of Sample) was found.

The following observations following the incubation period were observed. For Staphylococcus aureus, there was a partial interruption of growth under the specimen. The zone of inhibition was 0 mm. For Klebsiella pneumoniae there was also a partial interruption of growth under the specimen. The zone of inhibition was 0 mm.

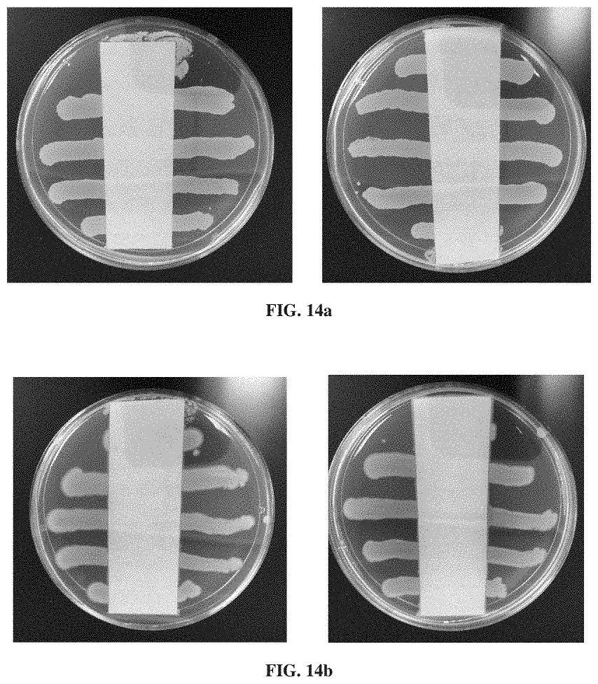

No formation of a distinct zone of inhibition was observed for either the Staphylococcus aureus or the Klebsiella pneumoniae. FIG. 13a depicts Staphylococcus aureus in contact with the sample; FIG. 13b depicts Klebsiella pneumoniae in contact with the sample.

Both species of bacterium can be seen growing on portions of agar/specimen interface. The full growth of the bacterium under the specimens was partially inhibited which is evident by the interruption of the inoculum streaks. The treated mats were not able to achieve a zone of inhibition with either inoculum.

These results suggest that mats treated with 2.6 ppm of slyer by way of Biomaster have low-mid strength anti-microbial properties. The mats partially resisted the growth of the bacteria inoculum streaked under the specimens. The lack of a zone of inhibition suggests that there is no migration or leaching of any antimicrobial component out of the mats that may “push back” the outlying growth.

### Example 16

The Silver Assay by ICP-OES and the efficacy testing per AATCC Test Method 147 were performed on 10½×14 unmarked mats (Ductor 120, Press Speed 600 FPM). Test swatches were prepared by cutting out portions of the plain mats. The swatches were laid out, face down, perpendicular to the inoculum, and incubated for 24 hours at 37±2° C. The plates were observed following the incubation period. The observations include examining the agar under the specimens for growth, as well as examining each swatch for a zone of inhibition. Zone of inhibition is defined as an area around each specimen in which the bacteria will not grow.

The silver results are listed below. These results are an average of two different samples run in duplicate. For the silver concentration, 2.4 ppm (ug silver/gm of Sample) was found.

The following observations following the incubation period were observed. For Staphylococcus aureus, there was a partial interruption of growth under the specimen. The zone of inhibition was 0 mm. For Klebsiella pneumoniae there was also a partial interruption of growth under the specimen. The zone of inhibition was 0 mm.

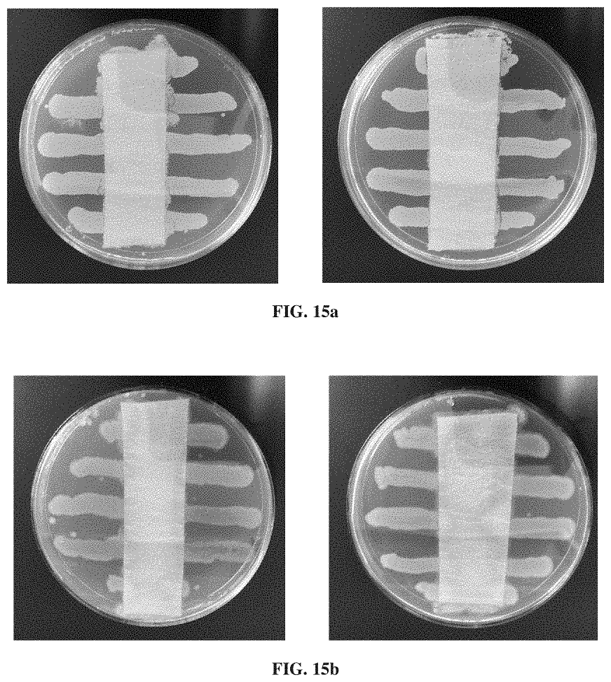

No formation of a distinct zone of inhibition was observed for either the Staphylococcus aureus or the Klebsiella pneumoniae. FIG. 14a depicts Staphylococcus aureus in contact with the sample; FIG. 14b depicts Klebsiella pneumoniae in contact with the sample.

Both species of bacterium can be seen growing on portions of agar/specimen interface. The full growth of the bacterium under the specimens was partially inhibited which is evident by the interruption of the inoculum streaks. The treated mats were not able to achieve a zone of inhibition with either inoculum.

These results suggest that mats treated with 2.4 ppm of silver by way of Biomaster have low-mid strength anti-microbial properties. The mats partially resisted the growth of the bacteria inoculum streaked under the specimens. The lack of a zone of inhibition suggests that there is no migration or leaching of any antimicrobial component out of the mats that may “push back” the outlying growth.

### Example 17

The Silver Assay by ICP-OES and the efficacy testing per AATCC Test Method 147 were performed on a Servotec Napkin 5% at 300 (96 M/M). Test swatches were prepared by cutting out portions of the napkins. The swatches were laid out, face down, perpendicular to the inoculum, and incubated for 24 hours at 37±2° C. The plates were observed following the incubation period. The observations include examining the agar under the specimens for growth, as well as examining each swatch for a zone of inhibition. Zone of inhibition is defined as an area around each specimen in which the bacteria will not grow.

The silver results are listed below. These results are an average of two different samples run in duplicate. For the silver concentration, 42.0 ppm (ug silver/gm of Sample) was found.

The following observations following the incubation period were observed. For Staphylococcus aureus, there was a partial interruption of growth under the specimen. The zone of inhibition was 0 mm. For Klebsiella pneumoniae there was also a partial interruption of growth under the specimen. The zone of inhibition was 0 mm.

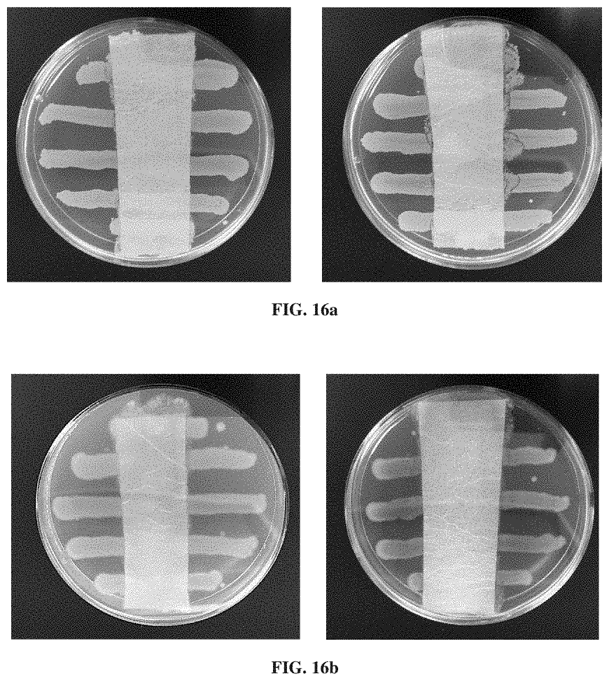

No formation of a distinct zone of inhibition was observed for either the Staphylococcus aureus or the Klebsiella pneumoniae. FIG. 15a depicts Staphylococcus aureus in contact with the sample; FIG. 15b depicts Klebsiella pneumoniae in contact with the sample.

Both species of bacterium can be seen growing on portions of agar/specimen interface. The full growth of the bacterium under the specimens was partially inhibited which is evident by the interruption of the inoculum streaks. The treated napkins were not able to achieve a zone of inhibition with either inoculum.

These results suggest that napkins treated with 42 ppm of silver by way of Biomaster have low-mid strength anti-microbial properties. The napkins partially resisted the growth of the bacteria inoculum streaked under the specimens. The lack of a zone of inhibition suggests that there is no migration or leaching of any antimicrobial component out of the napkins that may “push back” the outlying growth.

### Example 18

The Silver Assay by ICP-OES and the efficacy testing per AATCC Test Method 147 were performed on a Servotec Napkin 5% at 300 (170 M/M). Test swatches were prepared by cutting out portions of the napkins. The swatches were laid out, face down, perpendicular to the inoculum, and incubated for 24 hours at 37±2° C. The plates were observed following the incubation period. The observations include examining the agar under the specimens for growth, as well as examining each swatch for a zone of inhibition. Zone of inhibition is defined as an area around each specimen in which the bacteria will not grow.

The silver results are listed below. These results are an average of two different samples run in duplicate. For the silver concentration, 4.4 ppm (ug silver/gm of Sample) was found.

The following observations following the incubation period were observed. For Staphylococcus aureus, there was a partial interruption of growth under the specimen. The zone of inhibition was 0 mm. For Klebsiella pneumoniae there was also a partial interruption of growth under the specimen. The zone of inhibition was 0 mm.

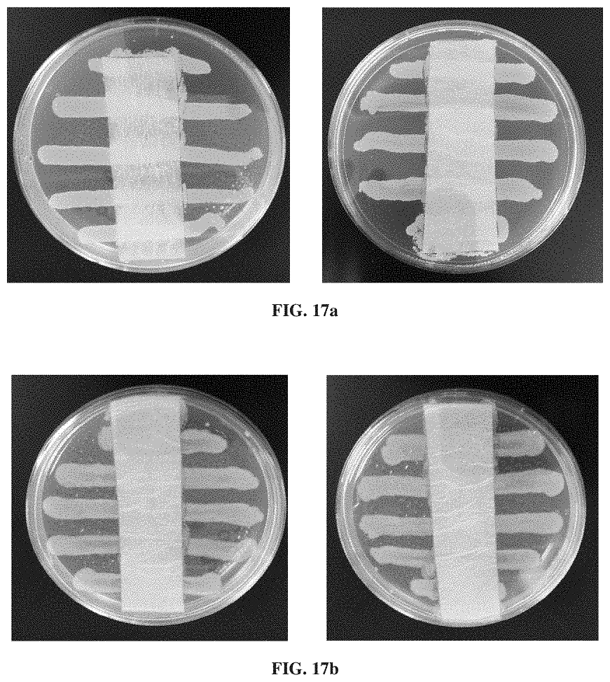

No formation of a distinct zone of inhibition was observed for either the Staphylococcus aureus or the Klebsiella pneumoniae. FIG. 16a depicts Staphylococcus aureus in contact with the sample; FIG. 16b depicts Klebsiella pneumoniae in contact with the sample.

Both species of bacterium can be seen growing on portions of agar/specimen interface. The full growth of the bacterium under the specimens was partially inhibited which is evident by the interruption of the inoculum streaks. The treated napkins were not able to achieve a zone of inhibition with either inoculum.

These results suggest that napkins treated with 4.4 ppm of silver by way of Biomaster have low-mid strength anti-microbial properties. The napkins partially resisted the growth of the bacteria inoculum streaked under the specimens. The lack of a zone of inhibition suggests that there is no migration or leaching of any antimicrobial component out of the napkins that may “push back” the outlying growth.

### Example 19

The Silver Assay by ICP-OES and the efficacy testing per AATCC Test Method 147 were performed on a BioShield napkin sample. Test swatches were prepared by cutting out portions of the napkins. The swatches were laid out, face down, perpendicular to the inoculum, and incubated for 24 hours at 37±2° C. The plates were observed following the incubation period. The observations include examining the agar under the specimens for growth, as well as examining each swatch for a zone of inhibition. Zone of inhibition is defined as an area around each specimen in which the bacteria will not grow.

The silver results are listed below. These results are an average of two different samples run in duplicate. For the silver concentration, 75 ppm (ug silver/gm of Sample) was found.

The following observations following the incubation period were observed. For Staphylococcus aureus, there was a partial interruption of growth under the specimen. The zone of inhibition was 0 mm. For Klebsiella pneumoniae there was a complete interruption of growth under the specimen. The zone of inhibition was 0 mm.

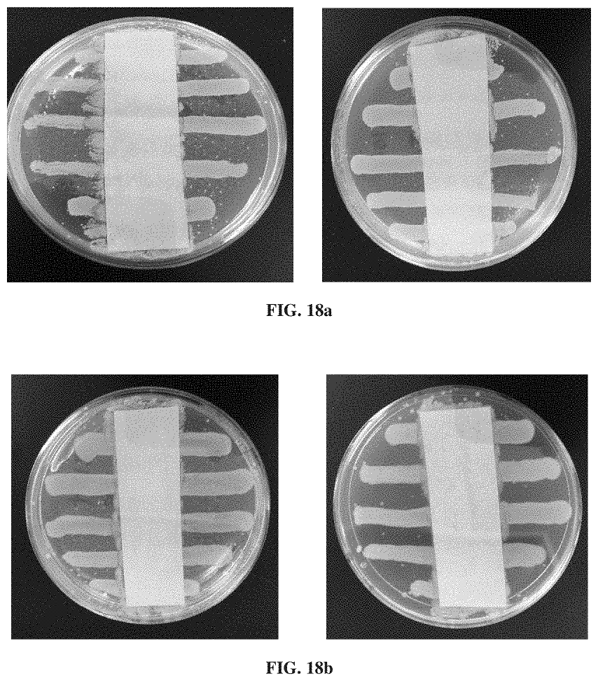

No formation of a distinct zone of inhibition was observed for either the Staphylococcus aureus or the Klebsiella pneumoniae. FIG. 17a depicts Staphylococcus aureus in contact with the sample; FIG. 17b depicts Klebsiella pneumoniae in contact with the sample.

The Staphylococcus aureus can be seen growing on portions of agar/specimen interface. The full growth of the bacterium under the specimens was partially inhibited which is evident by the interruption of the inoculum streaks. The Klebsiella pneumonia was not visible on the interface between the agar and the napkin. This indicates a complete interruption in the growth. The treated napkins were not able to achieve a zone of inhibition with either inoculum.

These results suggest that napkins treated with 75 ppm of silver have superior anti-microbial properties against the Klebsiella pneumonia and moderate anti-microbial properties against the Staphylococcus aureus. The lack of a zone of inhibition suggests that there is no migration or leaching of any antimicrobial component out of the napkins that may “push back” the outlying growth.

### Example 20

The Silver Assay by ICP-OES and the efficacy testing per AATCC Test Method 147 were performed on sample BioShield guest towels. Test swatches were prepared by cutting out portions of the guest towels. The swatches were laid out, face down, perpendicular to the inoculum, and incubated for 24 hours at 37±2° C. The plates were observed following the incubation period. The observations include examining the agar under the specimens for growth, as well as examining each swatch for a zone of inhibition. Zone of inhibition is defined as an area around each specimen in which the bacteria will not grow.

The silver results are listed below. These results are an average of two different samples run in duplicate. For the silver concentration, 0.5 ppm (ug silver/gm of Sample) was found.

The following observations following the incubation period were observed. For Staphylococcus aureus, there was a partial interruption of growth under the specimen. The zone of inhibition was 0 mm. For Klebsiella pneumoniae there was also a partial interruption of growth under the specimen. The zone of inhibition was 0 mm.

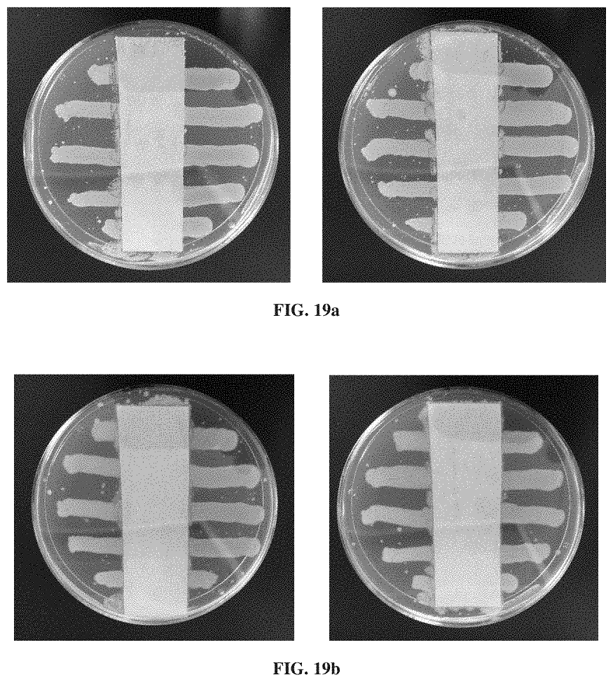

No formation of a distinct zone of inhibition was observed for either the Staphylococcus aureus or the Klebsiella pneumoniae. FIG. 18a depicts Staphylococcus aureus in contact with the sample; FIG. 18b depicts Klebsiella pneumoniae in contact with the sample.

Both species of bacterium can be seen growing on portions of agar/specimen interface. The full growth of the bacterium under the specimens was partially inhibited which is evident by the interruption of the inoculum streaks. The treated towels were not able to achieve a zone of inhibition with either inoculum.

These results suggest that towels treated with 0.5 ppm of silver have low-mid strength anti-microbial properties. The towels partially resisted the growth of the bacteria inoculum streaked under the specimens. The lack of a zone of inhibition suggests that there is no migration or leaching of any antimicrobial component out of the towels that may “push back” the outlying growth.

### Example 21

The Silver Assay by ICP-OES and the efficacy testing per AATCC Test Method 147 were performed on guest towel with 5% Biomaster at 150 (285 M/M). Test swatches were prepared by cutting out portions of the guest towels. The swatches were laid out, face down, perpendicular to the inoculum, and incubated for 24 hours at 37±2° C. The plates were observed following the incubation period. The observations include examining the agar under the specimens for growth, as well as examining each swatch for a zone of inhibition. Zone of inhibition is defined as an area around each specimen in which the bacteria will not grow.

The silver results are listed below. These results are an average of two different samples run in duplicate. For the silver concentration, 21.1 ppm (ug silver/gm of Sample) was found.

The following observations following the incubation period were observed. For Staphylococcus aureus, there was a partial interruption of growth under the specimen. The zone of inhibition was 0 mm. For Klebsiella pneumoniae there was a complete interruption of growth under the specimen. The zone of inhibition was 0 mm.

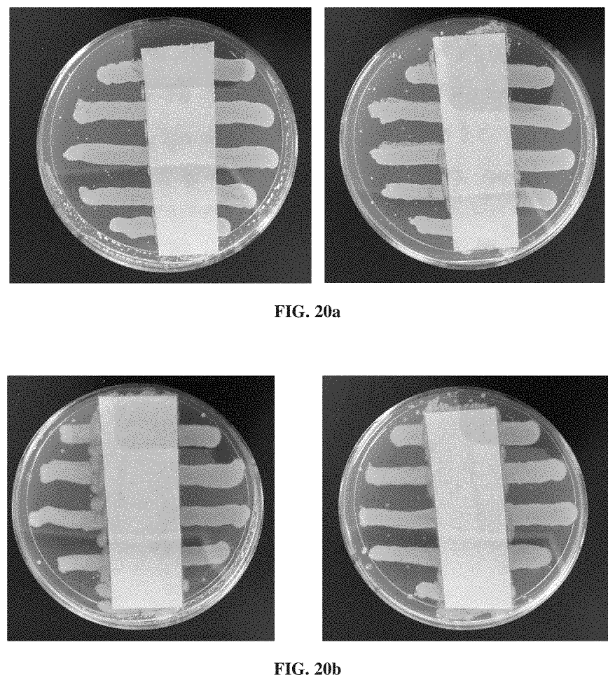

No formation of a distinct zone of inhibition was observed for either the Staphylococcus aureus or the Klebsiella pneumoniae. FIG. 19a depicts Staphylococcus aureus in contact with the sample; FIG. 19b depicts Klebsiella pneumoniae in contact with the sample.

The Staphylococcus aureus can be seen growing under portions of the specimens. The full growth of the bacterium under the specimens was partially inhibited which is evident by the interruption of the Staphylococcus aureus streaks. No Klebsiella pneumonia was observed growing under the specimens. The growth was completely inhibited. The treated guest towels were not able to achieve a zone of inhibition with either inoculum.

These results suggest that guest towels treated with 21.1 ppm of silver by way of Biomaster have excellent anti-microbial properties against the Klebsiella pneumonia. The guest towels completely resisted the growth of the Klebsiella inoculum streaked under the specimens. The towels were able to partially inhibit the growth of the Staphylococcus aureus. This result indicates that the treated towels do offer an anti-microbial effect on the Staphylococcus. The lack of a zone of inhibition suggests that there is no migration or leaching of any antimicrobial component out of the mats that may “push back” the outlying growth.

### Example 22

The Silver Assay by ICP-OES and the efficacy testing per AATCC Test Method 147 were performed on guest towels treated with 5% Biomaster at 300 (285 M/M). Test swatches were prepared by cutting out portions of the guest towels. The swatches were laid out, face down, perpendicular to the inoculum, and incubated for 24 hours at 37±2° C. The plates were observed following the incubation period. The observations include examining the agar under the specimens for growth, as well as examining each swatch for a zone of inhibition. Zone of inhibition is defined as an area around each specimen in which the bacteria will not grow.

The silver results are listed below. These results are an average of two different samples run in duplicate. For the silver concentration, 19.6 ppm (ug silver/gm of Sample) was found.

The following observations following the incubation period were observed. For Staphylococcus aureus, there was a partial interruption of growth under the specimen. The zone of inhibition was 0 mm. For Klebsiella pneumoniae there was complete interruption of growth under the specimen. The zone of inhibition was 0 mm.

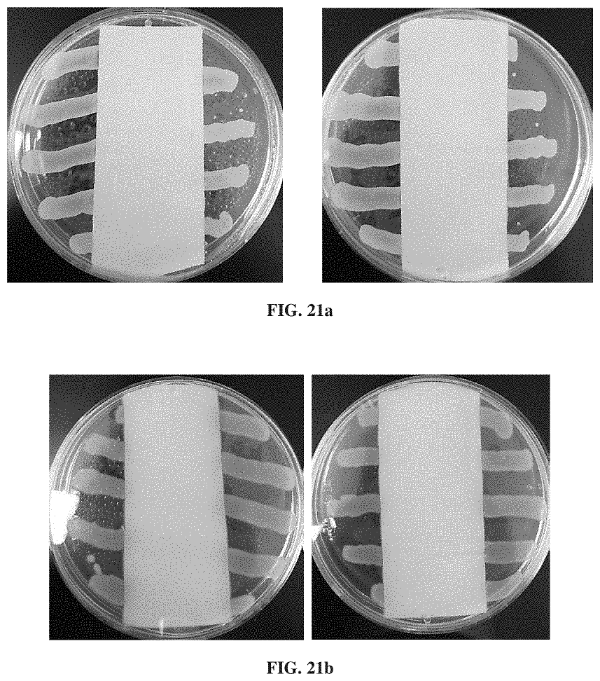

No formation of a distinct zone of inhibition was observed for either the Staphylococcus aureus or the Klebsiella pneumoniae. FIG. 20a depicts Staphylococcus aureus in contact with the sample; FIG. 20b depicts Klebsiella pneumoniae in contact with the sample.

The Staphylococcus aureus can be seen growing under portions of the specimens. The full growth of the bacterium under the specimens was partially inhibited which is evident by the interruption of the Staphylococcus aureus streaks. No Klebsiella pneumonia was observed growing under the specimens. The growth was completely inhibited. The treated guest towels were not able to achieve a zone of inhibition with either inoculum.

These results suggest that guest towels treated with 19.6 ppm of silver by way of Biomaster have excellent anti-microbial properties against the Klebsiella pneumonia. The guest towels completely resisted the growth of the Klebsiella inoculum streaked under the specimens. The towels were able to partially inhibit the growth of the Staphylococcus aureus. This result indicates that the treated towels do offer an anti-microbial effect on the Staphylococcus. The lack of a zone of inhibition suggests that there is no migration or leaching of any antimicrobial component out of the mats that may “push back” the outlying growth.

### Example 23

The Silver Assay by ICP-OES and the efficacy testing per AATCC Test Method 147 were performed on a 10×14 Placemat with BioShield Logo, coated on both sides with 2% Antimicrobial (Trans White). Test swatches were prepared by cutting out portions of the placemats. The swatches were laid out, face down, perpendicular to the inoculum, and incubated for 24 hours at 37±2° C. The plates were observed following the incubation period. The observations include examining the agar under the specimens for growth, as well as examining each swatch for a zone of inhibition. Zone of inhibition is defined as an area around each specimen in which the bacteria will not grow.

The silver results are listed below. These results are an average of two different samples run in duplicate. For the silver concentration, 4.9 ppm (ug silver/gm of Sample) was found.

The following observations following the incubation period were observed. For Staphylococcus aureus, there was a partial interruption of growth under the specimen, on both the printed and non-printed side of the sample. The zone of inhibition was 0 mm. For Klebsiella pneumoniae there was also a partial interruption of growth under the specimen, on both the printed and non-printed side of the sample. The zone of inhibition was 0 mm.

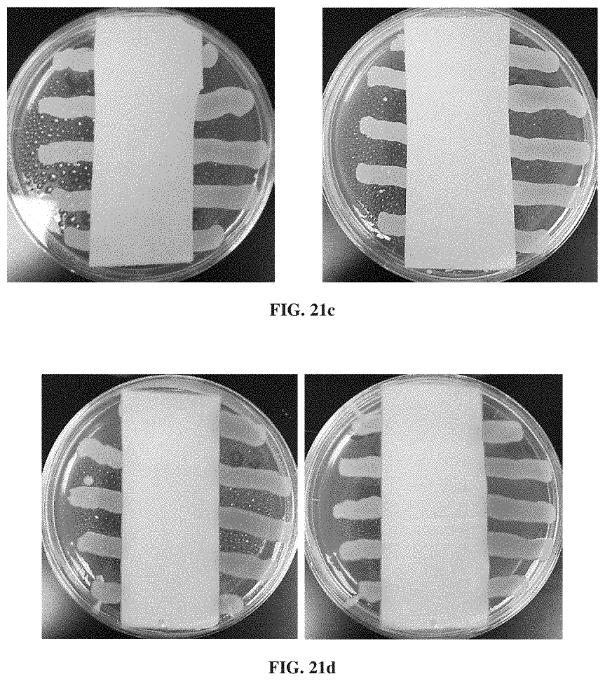

No formation of a distinct zone of inhibition was observed for either the Staphylococcus aureus or the Klebsiella pneumoniae. FIG. 21a depicts Staphylococcus aureus in contact with the printed side of the sample; FIG. 21b depicts Klebsiella pneumoniae in contact with the printed side of the sample; FIG. 21c depicts Staphylococcus aureus in contact with the printed side of the sample; FIG. 21d depicts Klebsiella pneumoniae in contact with the printed side of the sample.

The placemats contained, on average, 4.9 ppm of silver. This concentration of silver was able to partially interrupt the growth of both the Staphylococcus aureus and Klebsiella pneumonia under the test specimens on both the printed and non-printed side.

These results suggest that placemats treated with 4.9 ppm of silver have low-mid strength anti-microbial properties. The placemats partially resisted the growth of the bacteria inoculum streaked under the specimens. The lack of a zone of inhibition suggests that there is no migration or leaching of any antimicrobial component out of the placemats that may “push back” the outlying growth.

### Example 24

A Dynatec (Uniform Fiber Depositor) spray-system to apply the silver chloride solution (such as Biomaster) to both sides of the conventional tissue or Airlaid web may be used, in order to operate at high speeds, up to 2000 feet per minute, versus printing the silver chloride solution onto the sheet. It is also contemplated to employ a spray system that can be operated at lower speeds, such as 2000 feet per minute, or less. The nozzles will be positioned 1 to 10 inches from the tissue web, such as, for example, from 1 to 2 inches from the sheet in order to overcome the effect of boundary layer air being carried by the sheet. The sheet may be 1-ply, 2-ply, or 3-ply depending on the final product. In the case of a multi-ply sheet the web may be split and the silver chloride solution applied to each ply separately. The web would then be recombined in the downstream process. The webs may be unbonded and embossed or glue laminated and embossed.

A foil may be placed ahead of the Uniform Fiber Depositor, in contact, partial contact or gapped, to reduce the boundary layer air and ensure precise application of the silver chloride solution. This foil may be an active or passive airfoil. In order to ensure anti-viral efficacy, tissue napkin will contain 10-1000 ppm of Silver, such as from 20 to 70 ppm silver, for example, 20 ppm, 25 ppm, 30 ppm, 35 ppm, 40 ppm, 45 ppm, 50 ppm, 55 ppm, 60 ppm, 65 ppm, and 70 ppm.

In order to ensure maximum effectiveness against severe acute respiratory syndrome-related coronavirus, such as COVID-19 (SARS-CoV-2), a cationic fixative may be added to fix the silver to the fibers of the tissue and the Airlaid. The fixative works by immobilizing the silver on the surface of the product via the process of ionic bonding. An example of such a fixative is Buckman 5031, available from Buckman Laboratories.

In order to ensure maximum effectiveness against COVID-19, in a printing process up to six printing decks may be used to print the solution, and more preferably two to three print decks. The cationic fixative may be applied in one to six print decks, and more preferably in one to two initial decks.

It is contemplated that the coated tissue napkin showed a reduction of COVID-19 ranging from 50 to 75% in 15 minutes, such as a reduction ranging from 50 to 70%, from 50 to 68%, from 50 to 65%, from 50 to 63%, from 50 to 60%, from 55 to 70%, from 55 to 68%, from 55 to 65%, from 55 to 63%, from 60 to 68%, and from 60 to 65%. In further embodiments, the coated tissue napkin showed a reduction of COVID-19 of 99% or greater in four hours. These results will be obtained with a silver content ranging from 20 to 70 ppm.

While the present disclosure has been shown and described with reference to particular aspects thereof, it will be understood that the present disclosure can be practiced, without modification, in other environments. For example, aspects of the present disclosure may be used in various settings, such as in schools, hospitals, clinics, doctor's offices, dental offices, long term and assisted living facilities, and restaurant and foodservice facilities. Additionally, while the description has been directed to napkins, guest towels, placemats, and tray mats, the foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. An absorbable and antiviral paper product, comprising:
at least one layer of material having a first side and a second side; and
a silver ion coating on at least one of the first side and the second side,
wherein the silver ion coating has a concentration of at least 1%.

2. The absorbable and antiviral paper product of claim 1, wherein the silver ion coating has a concentration of 1% to 10%.

3. The absorbable and antiviral paper product of claim 1, wherein the at least one layer of material forms a napkin.

4. The absorbable and antiviral paper product of claim 1, wherein the at least one layer of material forms a guest towel or paper towel.

5. The absorbable and antiviral paper product of claim 1, wherein the at least one layer of material includes at least one dimple, ridge, bump, or recess.

6. An antiviral paper product, comprising:
at least one layer of material having a first side and a second side;
at least one rounded corner; and
a silver ion coating on at least one side,
wherein the silver ion coating has a concentration of at least 1%.

7. The antiviral paper product of claim 6, wherein the silver ion coating has a concentration of 1% to 10%.

8. The antiviral paper product of claim 6, wherein the at least one layer of material forms traymat.

9. An antiviral, silver-ion containing paper product, comprising:
a sheet of material having a first side and a second side; and
a coating of silver-ion solution comprising a concentration of from 1 ppm to 1,000 ppm.

10. The silver-ion containing paper product of claim 9, wherein the sheet of material includes at least one preformed fold or perforation.

11. The silver-ion containing paper product of claim 9, wherein the sheet of material includes a first ply and a second ply.
